(19) United States
(12) Patent Application Publication
(10) Pub. No.: US 2016/0200156 A1
(43) Pub. Date: Jul. 14, 2016

(54) DEVICE AND METHOD FOR ESTIMATING TIRE PRESSURE OF VEHICLE

(71) Applicant: MANDO CORPORATION, Pyeongtaek-Si (KR)

(72) Inventor: Se Woong KIM, Gunpo-Si (KR)

(21) Appl. No.: 14/942,805

(22) Filed: Nov. 16, 2015

(30) Foreign Application Priority Data
Nov. 19, 2014 (KR) 10-2014-0161906

(51) Int. Cl. B60C 23/06; G01L 17/00

(52) U.S. Cl. CPC B60C 23/061; G01L 17/00

(57) ABSTRACT

Disclosed are a tire pressure estimating method and a tire pressure estimating device. The tire pressure estimating method of a tire pressure estimating device that stores a PCA weighting coefficient to perform the Principle Component Analysis (PCA) and an LDA discriminant coefficient to perform the Linear Discriminant Analysis (LDA) for an FFT signal pattern of a resonance frequency band of an Fast Fourier Transform (FFT) signal obtained through the FFT of a wheel speed signal, in order to distinguish between a plurality of tire pressure states, may include: detecting the wheel speed signal through a wheel speed sensor; performing the FFT for the detected wheel speed signal; projecting an FFT signal pattern of the resonance frequency band of the FFT signal onto a PCA space by using the PCA applied with the stored PCA weighting coefficient; and performing the LDA applied with the stored LDA discriminant coefficient with respect to the data that is projected onto the PCA space to then determine a tire pressure state corresponding to the data projected onto the PCA space.

### CROSS-REFERENCE TO RELATED APPLICATION

This application claims priority from and the benefit under 35 U.S.C. §119 (a of Korean Patent Application No. 10-2014-0161906, filed on Nov. 19, 2014, which is hereby incorporated by reference for all purposes as if fully set forth herein.

### BACKGROUND OF THE INVENTION

1. Field of the Invention

The present invention relates to a device and a method of estimating tire pressure, and more particularly, to a device and a method of estimating tire pressure of a vehicle based on a wheel speed signal that is detected by a wheel speed sensor for detecting a wheel speed of a vehicle.

2. Description of the Prior Art

In recent years, demands for improving the driving stability or mileage of vehicles have been growing, so vibrant research and development of element technology is in progress in order to meet the demands.

The tire state is one of the biggest factors that influences driving stability or mileage. The tires may be worn out or the tire pressure may be lowered by driving the vehicle for a long time.

Such a change in the tire pressure may deteriorate the driving stability or mileage. Therefore, it is important to continuously detect and monitor the tire pressure change.

In the prior art, the tire pressure may be estimated indirectly in a manner of detecting a difference between a wheel speed signal frequency of a wheel speed sensor, which changes with the deflation of the tire, and a reference value. This method utilizes resonance frequency that can be obtained through a frequency analysis of the wheel speed signal. That is, a current resonance frequency is compared with a predetermined reference frequency in order to thereby estimate the tire pressure.

In the conventional method, a single value of the first representative resonance frequency of the tire is calculated from the wheel speed signal in order to thereby determine the reduction in the tire pressure.

However, in the above-mentioned method, when the amount of change in the frequency is small, it is difficult to easily recognize the change in the tire pressure because the amount of change in only a single resonance frequency value is calculated.

### PRIOR ART REFERENCES

(Patent Document 1) Korea Patent Gazette No. 1373151 (5 Mar. 2014)

### SUMMARY OF THE INVENTION

The embodiment of the present invention provides a tire pressure estimating method and a tire pressure estimating device that effectively and accurately estimates the tire pressure by monitoring a change in the frequency characteristics of the resonance frequency band of the wheel speed signal.

In accordance with an aspect of the present invention, a method for estimating the tire pressure may include: detecting respective test wheel speed signals that correspond to a plurality of tire pressure states; performing the first Fast Fourier Transform (FFT) for the detected wheel speed signals; calculating a PCA weighting coefficient to project an FFT signal pattern of a resonance frequency band that includes resonance frequencies of the first FFT signals onto a PCA space by using the Principle Component Analysis (PCA); calculating a regression coefficient to distinguish between a plurality of groups that are projected onto the PCA space through the Regression Analysis after the PCA; storing the calculated PCA weighting coefficient and regression coefficient; detecting a wheel speed signal to be analyzed in order to detect the tire pressure state in a real situation; performing the second FFT with respect to the detected wheel speed signal to be analyzed; performing the PCA for the second FFT signal of the resonance frequency band by applying the stored PCA weighting coefficient; and performing the Regression Analysis by applying the stored regression coefficient in order to thereby determine the tire pressure state corresponding to the detected wheel speed signal to be analyzed.

In addition, in the calculating of the PCA weighting coefficient, the resonance frequency band has thirty one dimensions, and the PCA reduces thirty one dimensions to two or three dimensions.

In addition, the calculating of the PCA weighting coefficient is conducted in a frequency domain.

In addition, in the calculating of the LDA discriminant coefficient, the LDA discriminant coefficient is a line or a plane that passes through a plurality of groups that are projected onto the PCA space.

In addition, in the calculating of the LDA discriminant coefficient, the LDA discriminant coefficient is a plurality of lines or planes in the case where there are three or more groups that are projected onto the PCA space.

In accordance with another aspect of the present invention, a method for estimating the tire pressure of a tire pressure estimating device that stores a PCA weighting coefficient to perform the Principle Component Analysis (PCA) and an LDA discriminant coefficient to perform the Linear Discriminant Analysis (LDA) for an FFT signal pattern of a resonance frequency band of an Fast Fourier Transform (FFT) signal obtained through the FFT of a wheel speed signal, in order to distinguish between a plurality of tire pressure states, may include: detecting a wheel speed signal through a wheel speed sensor; performing the FFT for the detected wheel speed signal; projecting an FFT signal pattern of the resonance frequency band of the FFT signal onto a PCA space by using the PCA applied with the stored PCA weighting coefficient; and performing the LDA applied with the stored LDA discriminant coefficient with respect to the data that is projected onto the PCA space to then determine a tire pressure state corresponding to the data projected onto the PCA space.

In accordance with another aspect of the present invention, a method for estimating tire pressure may include: detecting respective test wheel speed signals that correspond to a plurality of tire pressure states; performing the first Fast Fourier Transform (FFT) for the detected wheel speed signals; calculating a PCA weighting coefficient to project an FFT signal pattern of a resonance frequency band that includes resonance frequencies of the first FFT signals onto a PCA space by using the Principle Component Analysis (PCA); calculating a regression coefficient to distinguish between a plurality of groups that are projected onto the PCA space through the Regression Analysis after the PCA; storing the calculated PCA weighting coefficient and regression coefficient; detecting a wheel speed signal to be analyzed in order to detect the tire pressure state in a real situation; performing the second FFT with respect to the detected wheel speed signal to be analyzed; performing the PCA for the second FFT signal of the resonance frequency band by applying the stored PCA weighting coefficient; and performing the Regression Analysis by applying the stored regression coefficient in order to thereby determine the tire pressure state corresponding to the detected wheel speed signal to be analyzed.

In accordance with another aspect of the present invention, a tire pressure estimating device that stores a PCA weighting coefficient to perform the Principle Component Analysis (PCA) and an LDA discriminant coefficient to perform the Linear Discriminant Analysis (LDA) for an FFT signal pattern of a resonance frequency band of an Fast Fourier Transform (FFT) signal obtained through the FFT of a wheel speed signal, in order to distinguish between a plurality of tire pressure states, the device comprising: a wheel speed sensor that detects a wheel speed; and an electronic control unit that detects a wheel speed signal through the wheel speed sensor, performs the FFT for the detected wheel speed signal, projects an FFT signal pattern of a resonance frequency band of the FFT signal onto a PCA space by using the PCA applied with the stored PCA weighting coefficient, and performs the LDA applied with the stored LDA discriminant coefficient with respect to the data that is projected onto the PCA space to then determine a tire pressure state corresponding to the data projected onto the PCA space.

According to the embodiment of the invention, since the change in the resonance frequency band of the wheel speed signal may be recognized as a whole instead of calculating the change in only a single resonance frequency value of the wheel speed signal, even with a small change in the frequency, the tire pressure can be quickly and accurately determined compared to the conventional method.

### BRIEF DESCRIPTION OF THE DRAWINGS

The above and other objects, features, and advantages of the present invention will be more apparent from the following detailed description taken in conjunction with the accompanying drawings, in which:

FIG. 1 is a configuration diagram of a tire pressure estimating device, according to an embodiment of the present invention;

FIG. 2 A is a control flowchart of a method for calculating a tuning parameter for use in a tire pressure estimating device, according to an embodiment of the present invention;

FIG. 2B is a control flowchart of a method for estimating the tire pressure in a tire pressure estimating device, according to an embodiment of the present invention;

FIG. 3 is a graph to explain the Fast Fourier Transform (FFT) of a wheel speed signal in a predetermined speed period in a tire pressure estimating method, according to an embodiment of the present invention;

FIG. 4 is a diagram showing the frequency change characteristics of an FFT signal when the tire pressure is in a normal state in the resonance frequency band of FIG. 3;

FIG. 5 is a diagram showing the frequency change characteristics of an FFT signal when the tire pressure decreases by 25% in the resonance frequency band of FIG. 3;

FIG. 6 is a diagram showing the frequency change characteristics of an FFT signal when the tire pressure decreases by 50% in the resonance frequency band of FIG. 3;

FIGS. 7A and 7B are diagrams to explain that the dimensions are reduced by using the Principle Component Analysis in a tire pressure estimating method, according to an embodiment of the present invention;

FIGS. 8A and 8B are diagrams to explain that thirty one dimensions are reduced to two dimensions by using the Principle Component Analysis of the FFT signal of the resonance frequency band of FIG. 3;

FIGS. 9A and 9B are diagrams to explain that thirty one dimensions are reduced to two dimensions by using the Principle Component Analysis to then distinguish between a normal state, a 25%-deflation state, and a 50%-deflation state by using the Linear Discriminant Analysis in a tire pressure estimating method, according to an embodiment of the present invention; and

FIG. 10 is a diagram to explain that the dimensions are reduced by using the Principle Component Analysis to then distinguish between a normal state, a 25%-deflation state, and a 50%-deflation state by using the Regression Analysis in a tire pressure estimating method, according to an embodiment of the present invention.

### DETAILED DESCRIPTION OF THE EXEMPLARY EMBODIMENTS

Hereinafter, embodiments of the present invention will be described in detail with reference to the accompanying drawings. The embodiments discussed below are provided by way of example to fully transfer the idea of the present invention to those skilled in the art to which the present invention belongs. The present invention are not limited to the embodiments described below, and may be embodied in other forms. Elements that are not related to the description will be omitted from the drawings in order to clarify the present invention, and the element may be illustrated to be exaggerated in its width, length, or thickness in the drawings for convenience. The same reference numerals represent the same elements throughout the specification.

In an embodiment of the present invention, the frequency band is obtained through the Fast Fourier Transform (FFT) signal processing, and the FFT of a resonance frequency band for each tire pressure state is calculated through actual data on a normal state and a deflation state of the tire. A change in the frequency band is identified using the Principle Component Analysis (PCA) method and the Linear Discriminant Analysis (LDA) method, which are signal processing methods.

The PCA is a statistical method in which cumbersome high dimensional data is to be reduced to manageable low dimensional data and the data is analyzed through the linear transformation that preserves the characteristics of the given data. Therefore, the PCA aims at reducing the dimensions of the data, and to this end, an eigenvector and an eigenvalue are calculated by using the Covariance Matrix of the data. The calculated eigenvector is used as a base for creating new data, and the eigenvalue is used as a measured value for reducing the dimensions. In the PCA, the data redundancy is measured by a correlation between the data, and the data is made to have a non-correlation. The PCA is an optimal linear transformation in terms of a Mean Square Error. In other words, the PCA is a method in which the data is projected onto an axis of which the distribution of data is most significant in the given data distribution in terms of space to then re-express the data with a new axis that does not have a correlation.

The PCA is useful to abbreviate and express the characteristics of a specific group, but it does not show subgroups in the group to be separated. Although the PCA can show the tire pressure state, it does not show a detailed current state of the tire pressure.

The LDA is a method that is made to express different groups to be clearly separated from each other. The LDA obtains line/plane equation to separate the groups, and can recognize the tire pressure state based on the area that the group belongs to with respect to the line/plane.

In addition, the embodiment of the present invention may distinguish between the normal state of the tire pressure, the 25%-deflation state, and the 50%-deflation state by applying the FFT method, the PCA method, and the LDA method to a wheel speed signal in sequence.

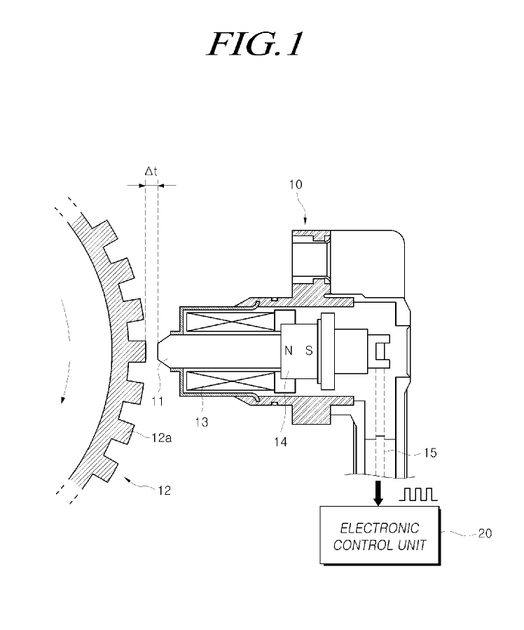

FIG. 1 is a configuration diagram of a tire pressure estimating device, according to an embodiment of the present invention.

Referring to FIG. 1, when the vehicle travels on the road, the tire vibrates due to the uneven road surface. The resonance frequency of the tire varies according to the tire pressure. For example, in the case of a normal tire pressure, the resonance frequency may approximate about 45 Hz. Therefore, the tire pressure may be monitored by detecting a change in the resonance frequency of the tire.

Since the resonance frequency of the tire corresponds to the resonance frequency of a wheel speed signal from a wheel speed sensor 10 for detecting a wheel speed, the tire pressure may be monitored using the resonance frequency of the wheel speed signal.

The wheel speed sensor 10 detects wheel speed information by generating a predetermined number of pulses according to the rotation of the wheel.

The wheel speed sensor 10 includes a pole piece 11 that is made of a magnetic material, and a rotor 12 that is mounted on the wheel to be rotated and to be spaced a predetermined distance (Δt) from the pole piece 11. In the configuration of the pole piece, the reference numerals 13, 14, and 15 denote a coil, a permanent magnet, and a signal lead line, respectively.

The rotor 12 has a saw-toothed gear 12a that is formed on the outer peripheral surface thereof. When the rotor 12 rotates, the gear 12a causes a change in the magnetic field to occur in the pole piece 11 in order to thereby output an alternating current signal. In addition, a wheel speed signal in the form of a pulse is made from the alternating current signal to then be provided to an electronic control unit 20. The pulse width of the wheel speed signal of a pulse form is inversely proportional to the wheel speed. That is, as the wheel speed increases, the pulse width decreases, whereas, as the wheel speed decreases, the pulse width increases.

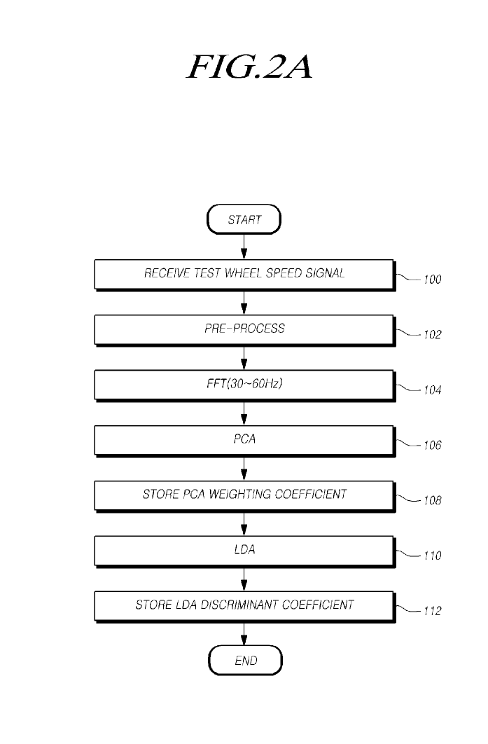

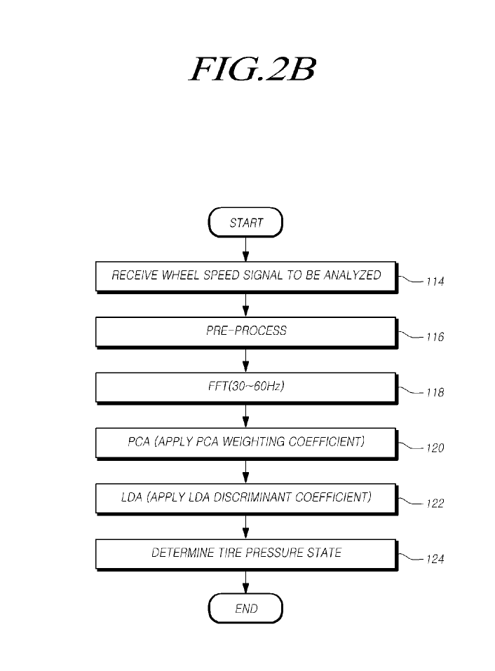

FIG. 2A is a control flowchart of a method for calculating a tuning parameter for use in the tire pressure estimating device, according to an embodiment of the present invention.

FIG. 2B is a control flowchart of a method for estimating the tire pressure in the tire pressure estimating device, according to an embodiment of the present invention.

The tuning parameter that is calculated in FIG. 2A includes a PCA weighting coefficient and an LDA discriminant coefficient.

Referring to FIGS. 2A and 2B, the tire pressure estimating method may be divided into an operation of obtaining and storing a PCA weighting coefficient and an LDA discriminant coefficient by analyzing the resonance frequency characteristics of a test wheel speed signal according to a plurality of tire pressure states by using the PCA and the LDA, and an operation of analyzing the resonance frequency characteristics of an actual wheel speed signal in a real situation by applying the stored PCA weighting coefficient and LDA discriminant coefficient to then determine the tire pressure state.

First, the operation of storing the PCA weighting coefficient and the LDA discriminant coefficient as the tuning parameter will be described. Referring to FIG. 2A, the operation of storing the PCA weighting coefficient and the LDA discriminant coefficient may include: operation 100 of receiving a test wheel speed signal; operation 102 of pre-processing the received wheel speed signal; operation 104 of performing the FFT with respect to a predetermined resonance frequency band (30 to 60 Hz) of the wheel speed signal; operation 106 of performing the PCA; operation 108 of storing the PCA weighting coefficient that is obtained in the operation of performing the PCA; operation 110 of performing the LDA; and operation 112 of storing the LDA discriminant coefficient that is obtained in the operation of performing the LDA.

First, in operation 100, a test wheel speed signal is received. The wheel speed signal is received to correspond to each of the tire pressure states to be tested. According to a plurality of tire pressure states to be tested, the wheel speed signals corresponding thereto are received. For example, a wheel speed signal in a normal state of the tire pressure, a wheel speed signal in a state in which the tire pressure is reduced by 25%, and a wheel speed signal in a state in which the tire pressure is reduced by 50% are received.

In operation 102 and operation 104, tone wheel offset adjustment, the re-sampling of the signal, and the band pass-filtering of the signal are performed with respect to the wheel speed signal for each tire pressure state, and at the same time, the FFT for the wheel speed signal is conducted.

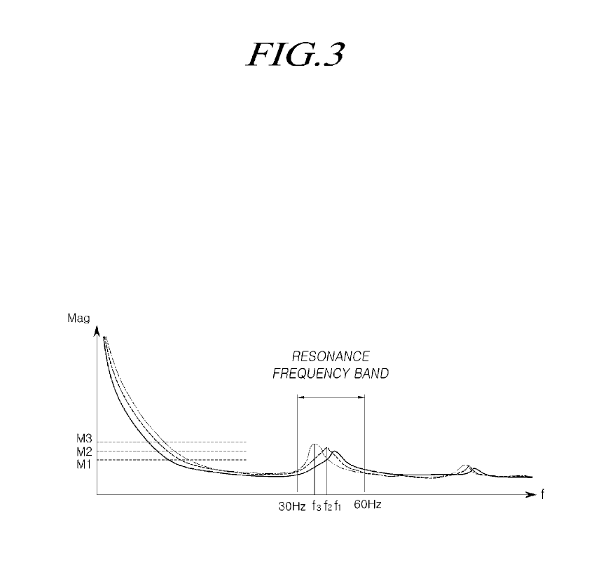

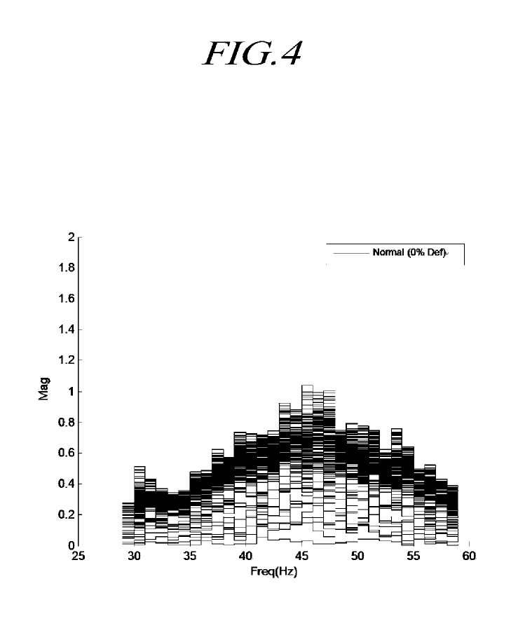

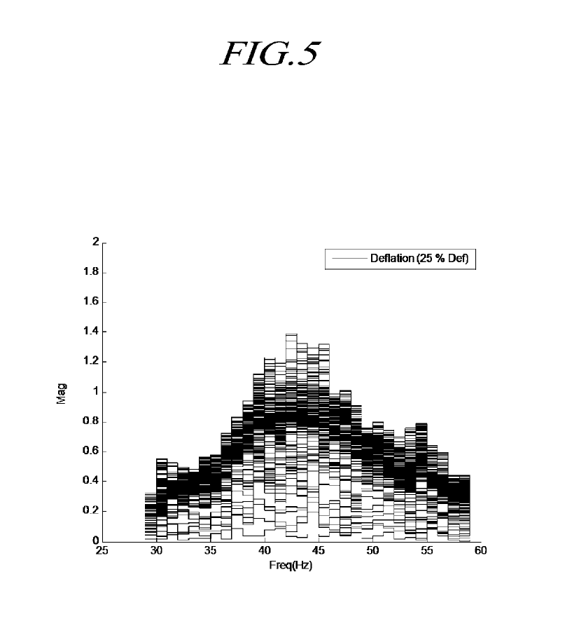

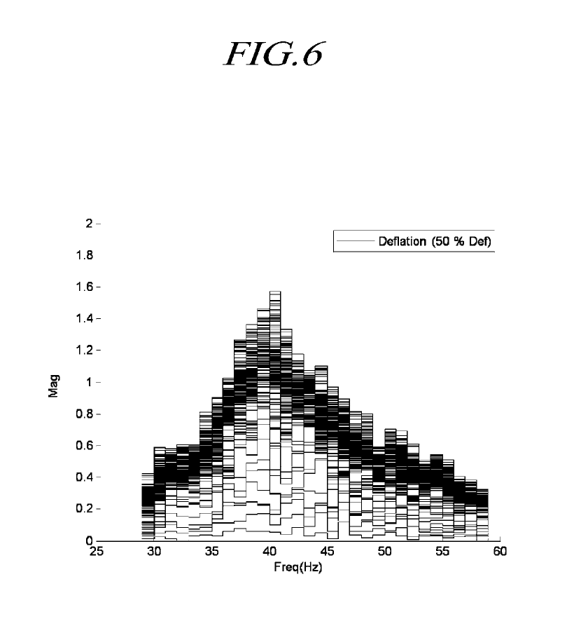

FIG. 3 is a graph to explain the Fast Fourier Transform (FFT) of the wheel speed signal in a predetermined speed period in the tire pressure estimating method, according to an embodiment of the present invention, and FIG. 4 is a diagram showing the frequency change characteristics of an FFT signal when the tire pressure is in the normal state in the resonance frequency band of FIG. 3. FIG. 5 is a diagram showing the frequency change characteristics of an FFT signal when the tire pressure decreases by 25% in the resonance frequency band of FIG. 3, and FIG. 6 is a diagram showing the frequency change characteristics of an FFT signal when the tire pressure decreases by 50% in the resonance frequency band of FIG. 3.

Referring to FIGS. 3 to 6, in operation 104, the FFT is conducted with respect to a wheel speed signal corresponding to a predetermined speed period among the wheel speed signals that have been filtered for each tire pressure state to be tested. Therefore, the FFT signal may be expressed as the frequency and magnitude of the FFT signal for each tire pressure state. For example, the FFT signal corresponding to the normal state of the tire pressure, the FFT signal corresponding to the state in which the tire pressure is reduced by 25%, and the FFT signal corresponding to the state in which the tire pressure is reduced by 50% may be expressed together.

These three FFT signals may be different from each other in the resonance frequency and magnitude depending on a difference in the tire pressure. The resonance frequency and magnitude of the FFT signal corresponding to the normal state of the tire pressure are f1 and M1, respectively.

In addition, the resonance frequency and magnitude of the FFT signal corresponding to the state in which the tire pressure is reduced by 25% are f2 that is lower than f1, and M2 that is greater than M1, respectively.

Meanwhile, the resonance frequency and magnitude of the FFT signal corresponding to the state in which the tire pressure is reduced by 50% are f3 that is lower than f3, and M3 that is greater than M2, respectively.

In operation 104, a certain frequency band, which includes all of the resonance frequencies of the three FFT signals, is configured as a resonance frequency band (for example, 30 to 60 Hz). Accordingly, it is possible to recognize the frequency and magnitude of the FFT signal in the configured resonance frequency band.

As shown in FIGS. 4 to 6, as the tire pressure decreases, the resonance frequency gradually decreases, whereas the magnitude of the resonance frequency increases. Although a change in the resonance frequency depending on the decrease in the tire pressure is not significant (such as, generally, 2 to 5 Hz) when the change in the resonance frequency exceeds 1 Hz due to the uneven road or the influence of other disturbances, the accuracy of the conventional tire pressure estimating method may be degraded due to the change in the resonance frequency. The conventional indirect tire pressure estimating method is vulnerable to disturbances because only a single value of the maximum resonance frequency of FIG. 3 is estimated through an adaptive filtering method or other methods. However, in the embodiment of the present invention, since an FFT pattern is compared in consideration of all of the FFT values in the resonance frequency band (30˜60 Hz), the method of the present invention may withstand the instantaneous disturbance.

Referring back to FIG. 2A, in operation 106, the PCA is performed after the FFT. The PCA is a signal processing method that is used for pattern recognition and image recognition, and the PCA reduces high-dimensional vectors to low-dimensional vectors. According to an embodiment of the present invention, since a vector that has thirty one dimensions in a resonance frequency band of 30 to 60 Hz (the dimension in the case of dividing the resonance frequency band value of 30 Hz by 1 Hz) is continuously calculated, the calculating dimensions are required to be low for a quick calculation.

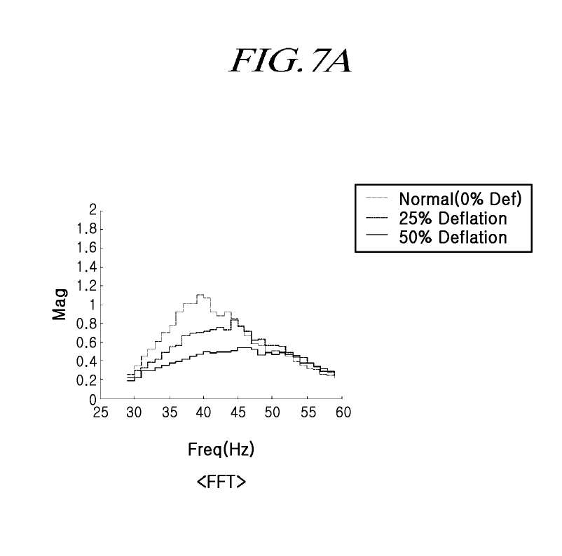

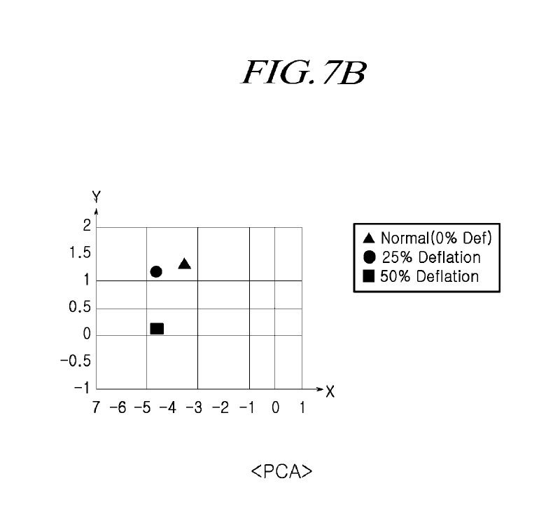

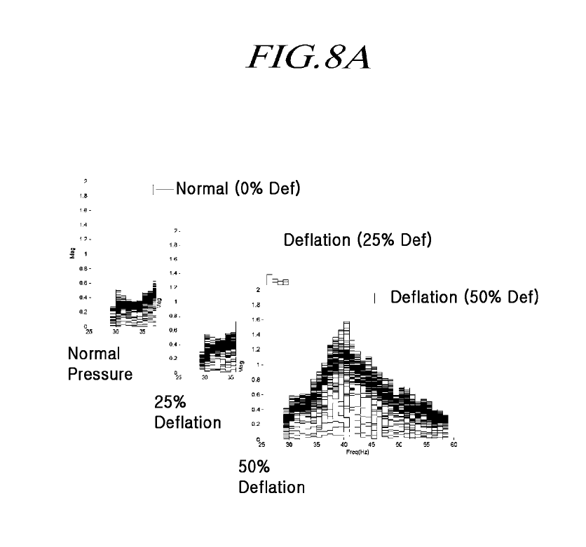

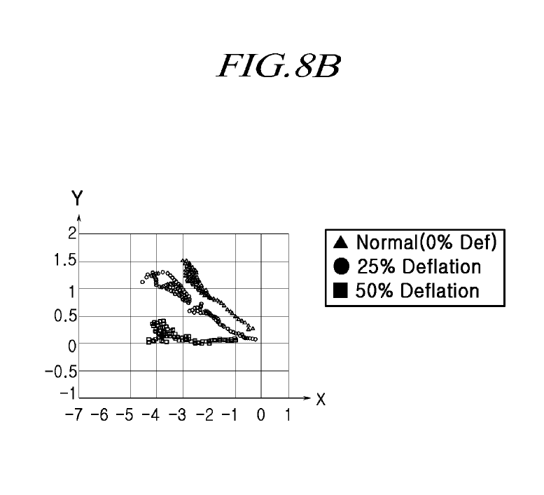

FIGS. 7A and 7B are diagrams to explain that the dimensions are reduced by using the Principle Component Analysis in a tire pressure estimating method, according to an embodiment of the present invention, and FIGS. 8A and 8B are diagrams to explain that thirty one dimensions are reduced to two dimensions by using the Principle Component Analysis of the FFT signal of the resonance frequency band of FIG. 3. Although the description of the present invention will be made of the case where thirty one dimensions are reduced to two dimensions or three dimensions through the PCA for convenience of explanation, the present invention is not limited thereto. That is, the present invention may encompass all of the cases where N dimensions are changed into M dimensions according to the configuration of the PCA wherein M denotes a natural number smaller than N.

As shown in FIGS. 7A-8B, a signal line (an FFT pattern) corresponding to each tire pressure state of the resonance frequency band (30 to 60 Hz) may be represented by a single point at the position determined by the PCA in a two-dimensional PCA space according to the execution of the PCA. That is, a signal line corresponding to the normal state of the tire pressure may be expressed as a triangle point, and a signal line corresponding to the state in which the tire pressure is reduced by 25% may be expressed as a circular point. In addition, a signal line corresponding to the state in which the tire pressure is reduced by 50% may be expressed as a rectangular point.

However, when performing the PCA, in order to project the signal line corresponding to the tire pressure state onto the corresponding position of the PCA space in a single point, a PCA weighting coefficient is required. The PCA weighting coefficient plays a role of projecting the signal line corresponding to the tire pressure state onto the corresponding position of the PCA space in a single point. The PCA weighting coefficient may be a matrix vector that has a main component vector that corresponds to the PCA dimensions.

FIGS. 8A and 8B show that thirty one dimensions are reduced to two dimensions. As shown in FIGS. 8A and 8B, when thirty one dimensions of the resonance frequency band are reduced to two dimensions or three dimensions, the normal state of the tire pressure, the state in which the tire pressure is reduced by 25%, and the state in which the tire pressure is reduced by 50% can be clearly distinguished from each other.

The PCA converts the axis into a different space by using eigenvectors of a Covariance Matrix. The calculation may include: creating a multi-dimensional Covariance Matrix of actual-dimensional data; sorting eigenvalues of the matrix into an order of size; and performing the inner product calculation for eigenvectors that are sorted in order of size and the actual-dimensional data to thereby reduce the calculation dimensions (the dimensions may be reduced to one dimension by using only one maximum eigenvalue, the dimensions may be reduced to two dimensions by using two maximum eigenvalues, and the dimensions may be reduced to three dimensions by using three maximum eigenvalues).

Here, the Covariance Matrix (S) and the eigenvalue (λ) using the actual data may be obtained through the offline calculation using Equation 1 below.

$$S = {\sum }_{k = 1}^{n} ( {x}_{k} - m ) {( {x}_{k} - m )}^{T} \qquad Equation 1$$

Here, S denotes the Covariance Matrix, and xₖ denotes a one-time FFT result (30˜60 Hz). m refers to an FFT average for each frequency of a learning data group, and λ refers to an eigenvalue of the Covariance Matrix. In addition, e represents an eigenvector of the Covariance Matrix.

At this time, e and λ are obtained from learning data, and the PCA method is applied by taking e values in order from a large A value to a small λ value.

Referring back to FIG. 2A, in operation 108, the PCA weighting coefficient is stored in the electronic control unit 20.

In addition, in operating 110, the LDA is performed.

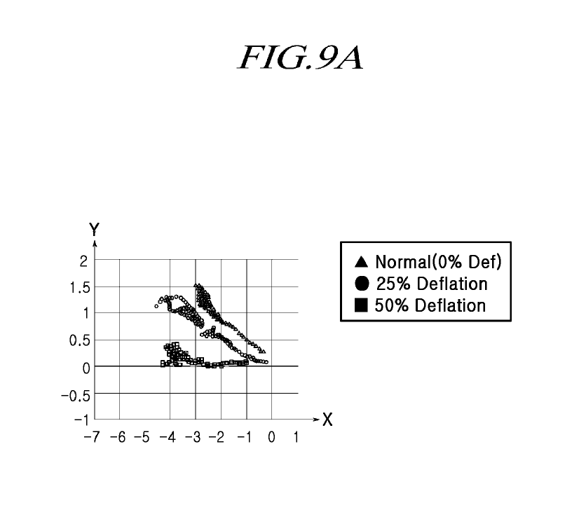

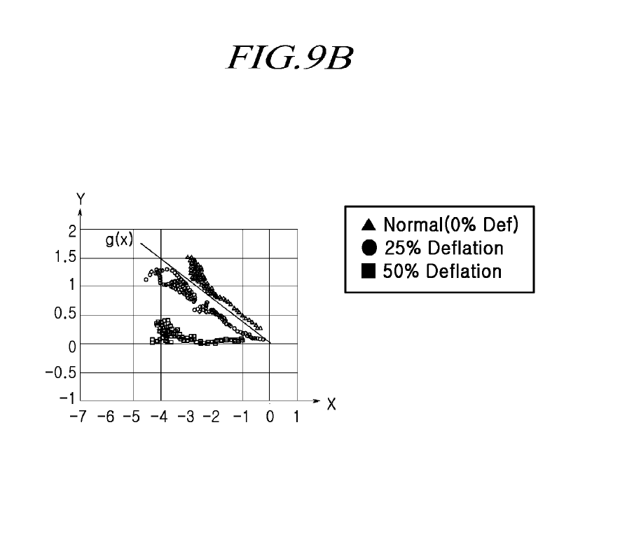

FIGS. 9A and 9B are diagrams to explain that thirty one dimensions are reduced to two dimensions by using the Principle Component Analysis to then distinguish between a normal state, a 25%-deflation state, and a 50%-deflation state by using the Linear Discriminant Analysis in a tire pressure estimating method, according to an embodiment of the present invention.

Referring to FIGS. 9A and 9B, the LDA discriminates the points on the PCA space after the PCA calculation. Like the PCA, an LDA discriminant coefficient, which is a line/plane equation to discriminate between groups, is obtained using the data that has been acquired through a signal processing method used in the signal processing and the image processing. In addition, if the point belongs to the upper area of the discriminated line/plane as the LDA discriminant coefficient, it is determined to be the normal state, and if the point belongs to the lower area of the discriminated line/plane, it is determined that the tire pressure is low.

Provided that g(x) and x denote a discriminant function, and a data input processed with the PCA after the FFT, respectively, and w and w0 denote weighting vectors, the discriminant function g(x) may be expressed as Equation 2 below.

g(x)=w^{t}x+w₀ Equation 2

The LDA discriminant coefficient may be expressed as the LDA discriminant function g(x).

Although a single function g(x) is used in order to discriminate between a triangular-point group and a circular-point group in the PCA space in FIGS. 9A and 9B, in the case of discriminating between a circular-point group and a rectangular-point group, another linear function g(x)′ may be used as well as the function g(x). In this case, the LDA discriminant coefficient may be expressed as g(x) and g(x)′.

Referring back to FIG. 2A, in operation 112, the LDA discriminant coefficient is stored in the electronic control unit 20.

As described above, since the normal state of the tire pressure, the state in which the tire pressure is reduced by 25%, and the state in which the tire pressure is reduced by 50% are distinguished from each other in the PCA space by using the PCA weighting coefficient and the LDA discriminant coefficient, when the wheel speed signal corresponding to the tire pressure in a real situation is processed with the FFT, the PCA, and the LDA, and positioned in the PCA space, it is easy to distinguish between the normal state, the 25%-deflation state, and the 50%-deflation state.

Hereinafter, the determination of the tire pressure state in a real situation will be described.

Referring to FIG. 2B, in order to estimate the tire pressure state in a real situation, the operation 114 of receiving a wheel speed signal to be analyzed, the operation 116 of the pre-processing, and the operation 118 of performing the FFT are carried out in the same manner as mentioned above.

In operation 120 of performing the PCA, the PCA is performed by applying the PCA weighting coefficient stored in operation 108 of FIG. 2A to the FFT signal of the resonance frequency band (30 to 60 Hz) with respect to the actual wheel speed signal in order to thereby display a point in the corresponding position in the PCA space. In addition, the tire pressure state is determined through the position of the point in the PCA space by applying the LDA discriminant coefficient that is stored in operation 122 (124).

Meanwhile, in operation 110 of FIG. 2A, even if the Regression Analysis is conducted instead of the LDA, the tire pressure state may be identified in the same manner. In other words, a regression coefficient used in the Regression Analysis may be used instead of the LDA coefficient.

The Regression Analysis is a statistical estimating method for analyzing the relationship between two or more variables, particularly, a causal relationship between the variables. The Regression Analysis infers the relationship by recognizing a mathematical linear function for a change in a specific variable and a change in another variable, and the inferred function is referred to as a regression equation. The regression equation enables an analysis on whether or not the change in a specific variable (referred to as an independent variable or a descriptive variable) is related to the change in another variable (referred to as a dependent variable), or which variable change corresponds to cause or effect. That is, the Regression Analysis refers to a statistical method to estimate the effect of the independent variables on one or more dependent variables, and in the Regression Analysis with a single independent variable, one equation represents a single line that passes through points that show the combined distribution of dependent and independent variables. This is called a regression line. The regression line most properly approximates the scattered points. A regression coefficient corresponds to the regression line.

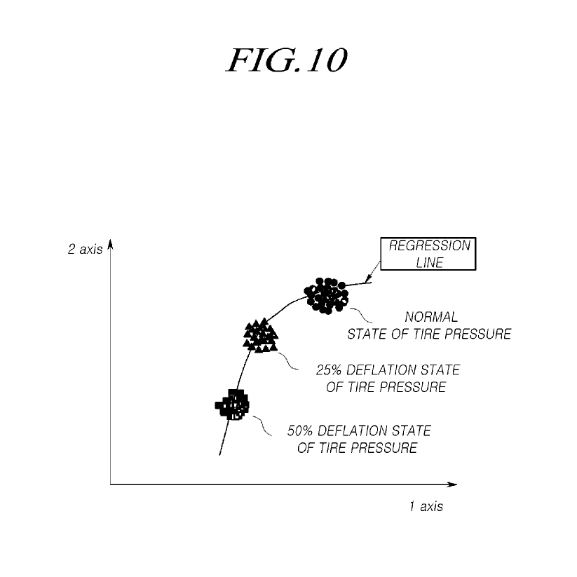

FIG. 10 is a diagram to explain that the dimensions are reduced by using the Principle Component Analysis to then distinguish between a normal state, a 25%-deflation state, and a 50%-deflation state by using the Regression Analysis in a tire pressure estimating method, according to an embodiment of the present invention.

Referring to FIG. 10, the regression process learns the data after the FFT process and estimates the amount of reduction in the tire pressure by the Regression Analysis.

In order to describe the regression process, the data after the PCA operation is illustrated. Provided that the horizontal axis is the first axis and the vertical axis is the second axis, the regression line, which corresponds to the regression coefficient, is drawn such that the regression line passes through the center of each point group in the PCA space or a nearby point of the center, and the tire pressure state may be determined based on the positions of the points of the groups on the regression line.

Meanwhile, the tire pressure estimating method, according to the present invention, may include detecting a wheel speed signal to be analyzed, which is received in a real driving situation, and comparing a pattern of a Fast Fourier Transform signal of the detected wheel speed signal with a pattern of a comparable Fourier Transform signal that is pre-stored to thereby determine the tire pressure state.

For example, as described above, the tire pressure estimating method may include detecting the wheel speed signal to be analyzed, and calculating the pattern of the Fast Fourier Transform signal by performing the FFT for the detected wheel speed signal. The calculated pattern of the Fast Fourier Transform signal is compared with a pattern of a comparable Fourier Transform signal that is pre-stored through experiments, by using a similarity analysis method in order to thereby determine the tire pressure state in the current driving state.

For example, the comparable Fourier Transform signal may be created by detecting a test wheel speed signal for each of a plurality of tire pressure states, and performing the FFT with respect to the detected test wheel speed signal. That is, patterns of the comparable Fourier Transform signals corresponding to the tire pressure states may be created and stored.

The present invention is not limited to a specific similarity analysis method. For example, the similarity between the Fast Fourier Transform signal pattern and the comparable Fourier Transform signal pattern may be calculated by the Euclidean distance similarity analysis, the cosine similarity analysis, or the Mahalanobis similarity analysis. In addition, a variety of analytical techniques to analyze the similarity between the two pieces of data may be applied. More specifically, in the case of using the Euclidean distance similarity analysis, a mean value is calculated by averaging the Fast Fourier Transform signals, and a Euclidean distance between the mean value and the comparable Fourier Transform signal for each tire pressure state is calculated to thereby determine the similarity. For another example, in the case of using the cosine similarity analysis, cosine angles are compared through the inner product of the Fast Fourier Transform signal and the comparable Fourier Transform signal in order to thereby determine the corresponding tire pressure state. For another example, in the case of using the Mahalanobis similarity analysis, the distance of the Fast Fourier Transform signal and the comparable Fourier Transform signal is calculated by using the Mahalanobis function in order to thereby determine the corresponding tire pressure state.

If the similarity between the Fast Fourier Transform signal pattern and the comparable Fourier Transform signal pattern exceeds a predetermined reference similarity, it is determined that the tire pressure corresponding to the comparable Fourier Transform signal pattern means the tire pressure of the current driving state.

What is claimed is:

1. A method for estimating the tire pressure of a tire pressure estimating device that stores a PCA weighting coefficient to perform the Principle Component Analysis (PCA) and an LDA discriminant coefficient to perform the Linear Discriminant Analysis (LDA) for an FFT signal pattern of a resonance frequency band of an Fast Fourier Transform (FFT) signal obtained through the FFT of a wheel speed signal, in order to distinguish between a plurality of tire pressure states, the method comprising:
detecting a wheel speed signal through a wheel speed sensor;
performing the FFT for the detected wheel speed signal;
projecting an FFT signal pattern of the resonance frequency band of the FFT signal onto a PCA space by using the PCA applied with the stored PCA weighting coefficient; and
performing the LDA applied with the stored LDA discriminant coefficient with respect to the data that is projected onto the PCA space to then determine a tire pressure state corresponding to the data projected onto the PCA space.

2. The method of claim 1, wherein the PCA weighting coefficient is determined by: detecting a test wheel speed signal that corresponds to each of a plurality of tire pressure states;
performing the Fast Fourier Transform (FFT) for the detected test wheel speed signal; and
calculating a value for projecting the FFT signal pattern of a resonance frequency band that includes the resonance frequencies of the test FFT signals, which are obtained by performing the FFT with respect to the test wheel speed signals, onto the PCA space by using the PCA.

3. The method of claim 2, wherein the LDA discriminant coefficient is determined by calculating a value for discriminating a plurality of groups that are projected onto the PCA space through the LDA with respect to the test wheel speed signals after the PCA.

4. The method of claim 3, wherein in the calculating of the LDA discriminant coefficient, the LDA discriminant coefficient is a line or a plane that passes through a plurality of groups that are projected onto the PCA space.

5. The method of claim 4, wherein in the calculating of the LDA discriminant coefficient, the LDA discriminant coefficient is a plurality of lines or planes in the case where there are three or more groups that are projected onto the PCA space.

6. The method of claim 2, wherein in the calculating of the PCA weighting coefficient, the resonance frequency band has N dimensions, and the PCA reduces N dimensions to M dimensions wherein N and M are natural numbers and N is greater than M.

7. The method of claim 6, wherein the N is thirty one, and the M is two or three.

8. The method of claim 2, wherein the calculating of the PCA weighting coefficient is conducted in a frequency domain.

9. A method for estimating the tire pressure, the method comprising:
detecting respective test wheel speed signals that correspond to a plurality of tire pressure states;
performing the first Fast Fourier Transform (FFT) for the detected wheel speed signals;
calculating a PCA weighting coefficient to project an FFT signal pattern of a resonance frequency band that includes resonance frequencies of the first FFT signals onto a PCA space by using the Principle Component Analysis (PCA);
calculating a regression coefficient to distinguish between a plurality of groups that are projected onto the PCA space through the Regression Analysis after the PCA;
storing the calculated PCA weighting coefficient and regression coefficient;
detecting a wheel speed signal to be analyzed in order to detect the tire pressure state in a real situation;
performing the second FFT with respect to the detected wheel speed signal to be analyzed;
performing the PCA for the second FFT signal of the resonance frequency band by applying the stored PCA weighting coefficient; and
performing the Regression Analysis by applying the stored regression coefficient in order to thereby determine the tire pressure state corresponding to the detected wheel speed signal to be analyzed.

10. A method for estimating the tire pressure, the method comprising:
detecting a wheel speed signal to be analyzed in order to detect the tire pressure state in a real situation;
performing the Fast Fourier Transform (FFT) for the detected wheel speed signal to be analyzed;
comparing a pattern of the Fast Fourier Transform signal with a pattern of a comparable Fourier Transform signal that is pre-stored; and
determining the tire pressure state corresponding to the wheel speed signal to be analyzed according to the comparison result.

11. The method of claim 10, further comprising:
detecting respective test wheel speed signals that correspond to a plurality of tire pressure states;
performing the Fast Fourier Transform (FFT) for the detected test wheel speed signals in order to thereby calculate a comparable Fourier Transform signal pattern; and
storing the comparable Fourier Transform signal pattern to correspond to each of the plurality of tire pressure states.

12. The method of claim 10, wherein in the comparing of the patterns, the similarity is compared between the pattern of the Fast Fourier Transform signal and the pattern of the comparable Fourier Transform signal.

13. The method of claim 12, wherein the similarity is determined based on at least one of the Euclidean distance similarity analysis, the cosine similarity analysis, or the Mahalanobis similarity analysis.

14. A tire pressure estimating device that stores a PCA weighting coefficient to perform the Principle Component Analysis (PCA) and an LDA discriminant coefficient to perform the Linear Discriminant Analysis (LDA) for an FFT signal pattern of a resonance frequency band of an Fast Fourier Transform (FFT) signal obtained through the FFT of a wheel speed signal, in order to distinguish between a plurality of tire pressure states, the device comprising:
a wheel speed sensor that detects a wheel speed; and
an electronic control unit that detects a wheel speed signal through the wheel speed sensor, performs the FFT for the detected wheel speed signal, projects an FFT signal pattern of a resonance frequency band of the FFT signal onto a PCA space by using the PCA applied with the stored PCA weighting coefficient, and performs the LDA applied with the stored LDA discriminant coefficient with respect to the data that is projected onto the PCA space to then determine a tire pressure state corresponding to the data projected onto the PCA space.
